(19) United States
(12) Patent Application Publication
(10) Pub. No.: US 2003/0224896 A1
(43) Pub. Date: Dec. 4, 2003

(54) Hydraulic differential lock

(76) Inventor: I-Chao Chung, Troy, MI (US)

Correspondence Address: HOWARD & HOWARD ATTORNEYS, P.C., The Pinehurst Office Center, Suite 101, 39400 Woodward Avenue, Bloomfield Hills, MI, 48304-5151, US

(21) Appl. No.: 10/438,731

(22) Filed: May 15, 2003

Related U.S. Application Data
(60) Provisional application No. 60/380,799, filed on May 15, 2002.

(51) Int. Cl. F16H 48/06

(52) U.S. Cl. 475/231

(57) ABSTRACT

A drive axle assembly includes a differential case that is operably coupled to a pair of axle shafts that drive vehicle wheels. A locking mechanism includes a clutch housing that is externally mounted to the differential case. The clutch housing defines a fluid chamber in which first and second sets of discs are mounted. The first set of discs is fixed for movement with the clutch housing and the second set of discs is fixed for movement with one of the axle shafts. An actuating mechanism is used to selectively compress the discs together to lock the clutch housing and associated differential case to the axle shaft under predetermined conditions. A fitting is fixed to the axle housing that defines a fluid path to connect an external fluid supply to the actuating mechanism. The fitting is resistant to torsional and axial movement resulting from the lock mechanism moving to a locked position by the actuating mechanism. The actuating mechanism includes a piston housing held fixed to the axle housing by the fitting as an actuation plate compresses the discs together. A piston is mounted within a piston chamber formed within the piston housing. Actuation thrust force is transferred from the stationary piston to the actuation plate through a pair of thrust bearings.

### RELATED APPLICATION

The application claims priority to U.S. Provisional Application No. 60/380,799, which was filed on May 15, 2002.

### TECHNICAL FIELD

This invention relates to a hydraulic differential lock for a drive axle. Specifically, a locking mechanism is externally mounted to eliminate leakage.

### BACKGROUND OF THE INVENTION

Vehicle drive axles typically include a pair of axle shafts for driving vehicle wheels. The drive axle uses a differential to control input speed and torque to the axle shafts. Under ideal conditions, when the vehicle is driven along a straight path, the wheels will be turning at approximately the same speed and the torque will be equally split between both wheels. When the vehicle negotiates a turn, the outer wheel must travel over a greater distance than the inner wheel. The differential allows the inner wheel to turn at a slower speed than the outer wheel as the vehicle turns.

Power is transmitted from a vehicle drive shaft to a drive pinion that is in constant mesh with a ring gear. The ring gear is bolted to a differential case that turns with the ring gear. A differential spider having four (4) support shafts orientated in the shape of a cross, has four (4) differential pinions. One differential pinion is supported for rotation on each support shaft. Power is transferred from the differential case to side gears that are splined to the axle shafts. The side gears are in constant mesh with the differential pinions. The outer ends of the axle shafts are bolted to the wheel hubs to which the wheels are mounted.

When the vehicle is driven in a straight path the ring gear, differential case, spider, differential pinions, and side gears all rotate as one unit to transfer power to the axle shafts. There is no relative movement between the differential pinions and the side gears. When the vehicle executes a turning maneuver, the differential pinion gears rotate on their respective shafts to speed up the rotation of one axle shaft while slowing the rotation of the other axle shaft.

Often the differential includes a locking or biasing mechanism. When there are poor traction conditions, e.g., slippery or rough surfaced roads, the biasing mechanism allows maximum wheel traction for improved control. If the differential does not have a biasing mechanism and one tire is on ice, the available traction torque on the opposite wheel is same as on the wheel on ice. Thus, the tire just spins on the ice and the vehicle is prohibited from traveling forward. A biasing mechanism allows the axle shafts to rotate at the same speed while transferring most of the available torque to the tire not on the ice. If the tractive effort at this tire is sufficient, the vehicle can be moved off of the ice. When the mechanism is activated, power is transmitted through the differential gearing, and biasing mechanism rather than through the differential gearing only.

One type of differential locking or biasing mechanism is comprised of a wet disc clutch that locks the differential case to the axle shafts, until a predetermined torque level is exceeded. The wet disc clutch includes a plurality of stationary discs interspersed with rotating discs in a fluid chamber. A piston applies a force to the wet disc clutch to compress the rotating and stationary discs together to apply torque between the differential case to be locked to the axle shafts. The terms stationary and rotating applied to the disc are relative to the differential case.

One disadvantage with a typical wet disc clutch system is fluid leakage. The leakage problem results from the pressurized fluid transfer from stationary members to rotating members to actuate the piston. Complicated rotating seal units, sometimes comprising leak-by recapture circuits, must be incorporated into the differential, which take up valuable packaging space and are expensive. The recapture system recovers the leaked fluid and returns it to a pump that is used for applying pressure to actuate the wet disc clutch. Another disadvantage is that the clutch torque capacity is limited by the discs and actuation mechanism that can be physically fit within the differential case.

Thus, it is desirable to have a simplified actuating mechanism for a differential lock that can deliver pressure from a stationary source to a rotating source while eliminating leakage, in addition to overcoming other deficiencies in the prior art as outlined above.

### SUMMARY OF THE INVENTION

A differential locking assembly for a vehicle drive axle is installed within an axle housing and external to a differential case. The locking assembly is resistive to both axial and torsional forces generated by a lock activation. A connector is used to connect an external fluid supply to the locking mechanism. The connector is fixed to the axle housing.

In one disclosed embodiment, the differential locking assembly includes a differential case and a differential gearing assembly mounted within the differential case and operably coupled to a pair of axle shafts for driving vehicle wheels. A clutch housing is mounted externally relative to the differential case. An actuator is mounted substantially within the clutch housing for selectively locking the clutch housing and differential case for rotation with one of the axle shafts under predetermined locking conditions. The clutch housing is designed to accommodate thrust and torsion forces resulting from activation of the locking mechanism.

Preferably, the locking mechanism includes a first plurality of discs mounted to the clutch housing and a second plurality of discs, interspersed with the first plurality of discs, mounted for rotation with the axle shaft.

In the preferred embodiment, the actuator includes a rotating member or actuation plate mounted with the clutch housing for rotation with the clutch housing. A piston housing is held fixed with the axle housing and includes a body portion extending into the clutch housing and a leg portion extending out radially from the body portion and external to the clutch housing. The connector includes a first portion that is fixed to the axle housing and a second portion that extends into the leg portion of the piston housing. A piston is mounted within a piston chamber formed within the body portion of the piston housing. A fluid path extends from the external fluid supply, through the connector and through the piston housing into the piston chamber. The actuation thrust force is transferred from the stationary piston to the rotating member via a pair of thrust bearings. Preferably, a ring is inserted over the leg portion, rotated approximately 90 degrees, and is attached to one end of the clutch housing. The ring provides a reaction surface for one of the thrust bearings.

The subject invention provides a differential locking mechanism that is easily incorporated into different axle carrier types with minimal component modification. The subject invention offers several advantages over a conventional positive-locking devices involving splines. Once activated, the differential remains locked until the torque exceeds the clutch capacity. This provides a means of automatically protecting the torque-carrying components from overload. Another major advantage is the much better ability to engage on-the-fly. When locking two components at different speeds, spline based devices are subjected to severe wear of the teeth, and can generate significant noise and vibration. Further, the subject invention provides a method and apparatus for transferring an actuation thrust force from a stationary member to a rotating member without the need for rotating seals. These and other features of the present invention can be best understood from the following specifications and drawings, the following of which is a brief description.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a cross-sectional view of a prior art differential with a locking mechanism;

FIG. 2 is a top cross-sectional view of a differential assembly with a locking mechanism in accordance with the subject invention;

FIG. 3 is a magnified view of section 3 as indicated in FIG. 2; and

FIG. 4 is a schematic view of an axle assembly incorporating the subject invention.

### DETAILED DESCRIPTION OF A PREFERRED EMBODIMENT

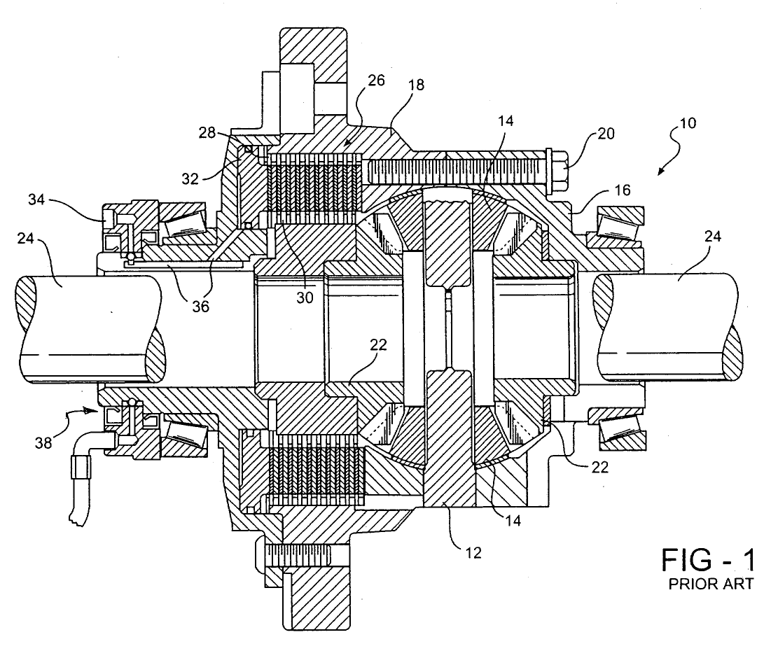

Referring to the Figures, where like numerals indicate like or corresponding parts throughout the several views, an axle differential with a prior art differential locking mechanism is shown generally at 10 in FIG. 1. The axle differential 10 includes a differential spider 12 having four (4) support shafts (only two (2) are shown) orientated in the shape of a cross, as is known in the art, with each shaft supporting one of four (4) differential pinions 14 (only two (2) are shown). The spider 12 and pinions 14 are mounted within a differential case that has a first half 16 and a second half 18 that are bolted together with a plurality of fasteners 20 (only one is shown). Power is transferred from the differential case to side gears 22 that are splined to axle shafts 24. The side gears 22 are in constant mesh with the differential pinions 14. The outer ends of the axle shafts 24 are locked in rotation to the wheel hubs (not shown) to which the wheels are mounted. A known in the art, the spider 12, pinions 14, and side gears 22 can make up at least part of a differential gear assembly.

When a vehicle is driven in a straight path the differential case 16, 18, spider 12, differential pinions 14, and side gears 22 all rotate as one unit to transfer power to the axle shafts 24. There is no relative movement between the differential pinions 14 and the side gears 22. When the vehicle executes a turning maneuver, the differential pinions 14 rotate on their respective shafts to speed up the rotation of one axle shaft 24 while slowing the rotation of the other axle shaft 24.

The following describes a clutch and actuation mechanism mounted inside the differential case. The differential 10 includes a locking mechanism comprising a wet disc clutch 26 that locks the differential case 16, 18 to one of the axle shafts 24. The wet disc clutch 26 includes a first plurality of discs 28 that are mounted internally to one of the differential case halves 16, 18 and, which are interspersed with a second plurality of discs 30 that are mounted internally within the other of the case halves 16, 18 for rotation with the axle shafts 24. The discs 28, 30 are mounted within a fluid chamber defined by the case halves 16, 18. A piston 32 applies a force to the wet disc clutch 26 to compress the discs 28, 30 together to reduce rotational speed and allow the differential case 16, 18 to be locked to the axle shaft 24.

A hydraulic input 34 supplies fluid to actuate the piston 32 via a fluid path 36. A sealing assembly 38 is used to provide a sealed environment as fluid flows from the input 34 to the piston 32 via the fluid path 36. This sealing assembly 38 is subjected to high rotational speeds and high fluid pressures, which leads to challenging seal designs and can result in undesirable leakage.

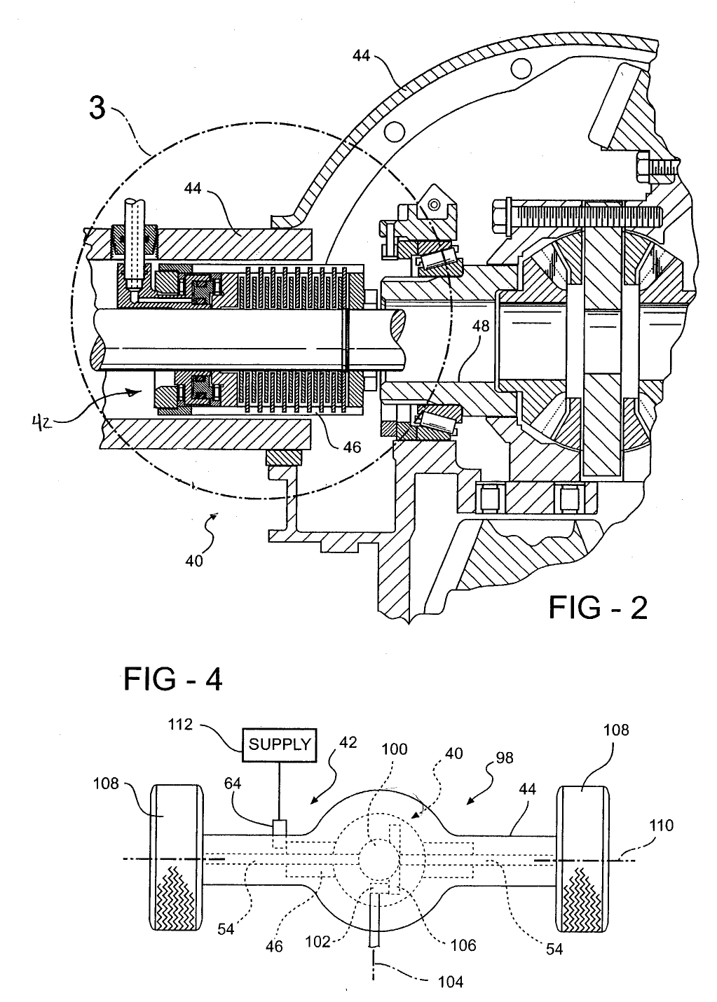

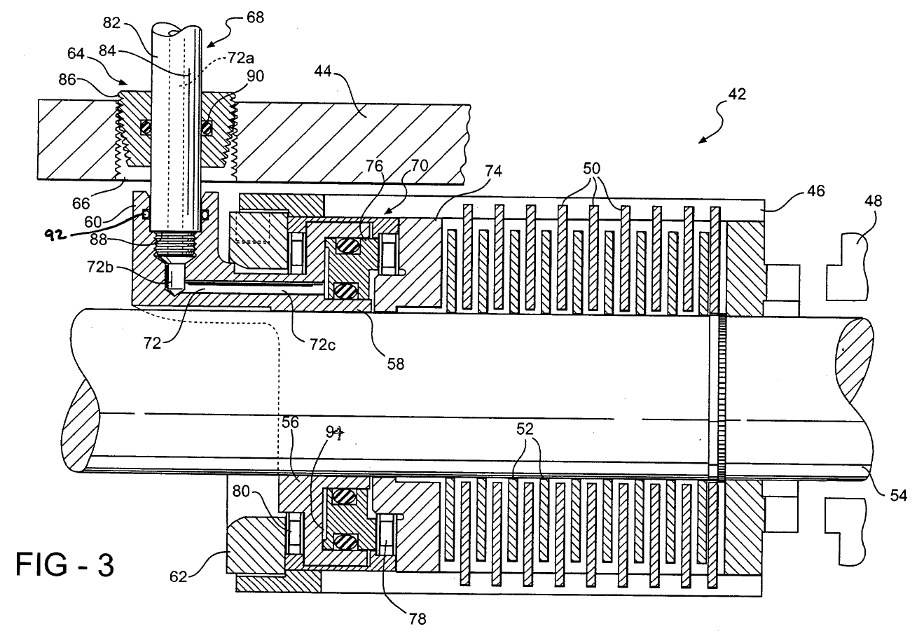

The subject invention, shown in FIGS. 2 and 3, eliminates fluid leakage by utilizing a differential locking mechanism that is mounted externally from the differential. An axle differential incorporating the subject invention is shown generally at 40 in FIG. 2. The differential 40 operates as described above, however, the differential 40 includes a locking mechanism 42 that has a first portion mounted externally to a differential case half 48 and a second portion that is mounted to an axle housing 44.

The first portion of the locking mechanism 42 comprises a clutch housing 46 that is externally mounted via teeth, splines, threaded connection, or other similar means to the differential case half 48. A first plurality of discs 50 are attached to the clutch housing 46 and a second plurality of discs 52 are attached to an axle shaft 54. The first 50 and second 52 plurality of discs are interspaced with each other, i.e. are mounted in an alternating pattern with each other, as is known in the art. The discs 50, 52 are mounted within a chamber defined within the clutch housing 46. The first discs 50 and clutch housing 46 rotate with the differential case half 48. The number of discs 50, 52 can vary depending upon the application.

A stationary member 56 is installed in one end of the clutch housing 46. Preferably the stationary member 56 is a piston housing 56. The piston housing 56 includes a cylindrical body portion 58 and a transversely extending leg 60. The leg 60 extends in a radial direction away from the axle shaft 54 and toward the axle housing 44. The leg 60 is preferably orientated at a right angle relative to the body portion 58.

An adjusting ring 62 is installed within the clutch housing 46 by first being installed in one direction over the leg 60 and then is rotated approximately 90 degrees to be threaded or otherwise attached to the clutch housing 46. The ring 62 surrounds and is spaced apart from the piston housing 56.

The second portion of the locking mechanism 42 includes a connector or fitting 64 that is installed through an opening 66 in the axle housing 44 to connect with the piston housing 56. The fitting 64 defines a fluid input 68 that supplies fluid to an actuating mechanism 70 via a fluid path 72. The connector 64 includes a first fluid path portion 72a, that is in fluid communication with a second fluid path portion 72b formed within the leg portion 60 of the stationary member 56, which in turn is in fluid communication with a third fluid path portion 72c formed within the body portion 58 of the piston housing 56.

The actuating mechanism 70 includes an actuation member 74 or actuation plate that is rotatable with the clutch housing 46 and moveable along a linear path in response to movement of a piston 76 to compress the discs 50, 52 together to lock the clutch housing 46 (and differential case half 48) to the axle shaft 54. The piston 76 is received within a piston chamber 94 formed within the body portion 58 of the piston housing 56. The fluid path 72 in the piston housing 56 is in fluid communication with the piston chamber 94.

A first bearing 78 is installed between the piston 76 and the actuation member 74 and a second bearing 80 is installed between the piston housing 56 and the ring 62. When a fluid pressure is applied to the piston 76 to move the actuation member 74, the fitting 64 holds the piston housing 56 stationary by providing resistance to torsional drag from bearings 78 and 80, as well as secondary axial forces external to the locking mechanism 42.. Thus, the fitting 64, by being anchored to the axle housing 44, supplies fluid to actuate the piston 76 while also providing a stabilizing effect by resisting torsional and axial forces generated during locking.

The fitting 64 includes a conduit or tube 82 that has a first portion 84 fitted through a plug 86 and a second portion 88 that extends into the piston housing 56. A first seal 90 surrounds the first portion 84 and a second seal 92 surrounds the second portion 88.

As shown in FIG. 4, the subject axle differential 40 is incorporated into a drive axle assembly 98. As described above, the axle differential 40 includes a differential gear assembly 100. An input pinion 102 defines a pinion axis of rotation 104 and is in meshing engagement with a ring gear 106, which is operably coupled to the differential 40. The differential gear assembly 100 is operably connected to drive the pair of axle shafts 54 that drive the vehicle wheels 108 about an axle shaft axis of rotation 110 that is typically perpendicular to the pinion axis of rotation 104.

An external fluid supply 112 is fluidly connected to the connector 64, which directs fluid to actuate the locking mechanism 42 in the clutch housing 46. Preferably, mineral oil is used, however, any type of fluid known in the art could be used.

The subject invention provides a hydraulic differential lock that is installed outside of the differential case. The piston 76 squeezes the first and second plurality of discs 50, 52, which applies a torque between the axle shaft 54 and clutch housing 46, which is coupled to the differential case. The actuation thrust force is transferred from the stationary piston 76 to the rotating discs 50, 52 through thrust bearings 78, 80, thus eliminating the need for rotating seals. The clutch housing 46 is capable of taking both thrust and torsion, which saves radial room for the discs 50, 52. Connection to the external hydraulic system is done through the dual-function connector/fitting 64 that transfers fluid and restrains the clutch assembly both axially and rotatively. The subject invention further provides the benefits of being easily adapted to different carriers at low cost, being capable of smoothly engaging on-the-fly, and automatically protecting torque-carrying components from overload.

Although a preferred embodiment of this invention has been disclosed, one of ordinary skill in this art would recognize that certain modifications would come within the scope of this invention. For that reason, the following claims should be studied to determine the true scope and content of this invention.

1. A drive axle assembly for driving vehicle wheels comprising:
an axle housing;
a differential case disposed within said axle housing;
a differential gear assembly mounted within said differential case;
a pair of axle shafts operably coupled to said gear assembly for driving the vehicle wheels wherein said axle shafts can rotate at different speeds;
a locking mechanism coupled to said differential case and selectively movable from an unlocked position for allowing the axle shafts to selectively rotate at different speeds to a locked position where said differential case is locked to said axle shafts for preventing relative rotation of said axle shafts; and
a clutch housing mounted to said axle housing external of said differential case with said locking mechanism disposed within said clutch housing wherein said clutch housing is resistant to torsional and axial movement resulting from said locking mechanism moving to said locked position.

2. The drive axle assembly according to claim 2 wherein said locking mechanism includes a first plurality of discs mounted directly to said clutch housing and a second plurality of discs mounted directly to said one of said axle shafts and interspersed with said first plurality of discs.

3. The drive axle assembly according to claim 2 wherein said discs are mounted within a fluid chamber formed within said clutch housing.

4. The drive axle assembly according to claim 3 further including an actuating mechanism disposed within said clutch housing for selectively compressing said first and second plurality of discs together to lock said clutch housing for rotation with said one of said axle shafts when said locking mechanism is moved to said locked position.

5. The drive axle assembly according to claim 4 wherein said actuating mechanism includes at least one piston for applying a linear actuation force to compress said first and second plurality of discs together.

6. The drive axle assembly according to claim 5 further including an actuation member selectively coupled to said piston and slidable relative to said clutch housing to engage and compress said discs.

7. The drive axle according to claim 6 further including a bearing coupled between said piston and said actuation member.

8. The drive axle assembly according to claim 4 further including a fitting fixed to said axle housing and defining a fluid path to said actuating mechanism.

9. The drive axle assembly according to claim 5 further including a stationary member substantially enclosed by said clutch housing and held fixed relative to said axle housing.

10. The drive axle assembly according to claim 9 further including a ring fixed for rotation within said clutch housing and surrounding said stationary member.

11. The drive axle assembly according to claim 9 wherein said stationary member is further defined as a piston housing having a body portion mounted substantially within said clutch housing and a leg extending transversely from said body portion and radially outward from said axle shafts toward said axle housing.

12. The drive axle assembly according to claim 11 wherein said body portion is a cylindrical body member defining a piston chamber for receiving said piston such that said piston remains fixed relative to said axle housing.

13. The drive axle assembly according to claim 9 wherein said body portion defines a fluid path and said leg defines another fluid path transverse to and in communication with said fluid path of said body portion.

14. The drive axle assembly according to claim 13 further including a fitting fixed to said axle housing and connectable to said stationary member, said fitting defining another fluid path in communication with said fluid path of said leg.

15. The drive axle assembly according to claim 14 wherein said fitting restrains axial movement of said clutch housing along a path parallel to said axle shaft.

16. The drive axle assembly according to claim 15 wherein said fitting extends through said axle housing and is received within said stationary member.

17. The drive axle assembly according to claim 16 further including a plug directly engaged with said axle housing, said plug defining a central bore for receiving said fitting.

18. A method of assembling a differential locking mechanism for a drive axle comprising the steps of:
providing a clutch housing defining a fluid chamber, a first plurality of discs mounted to the clutch housing, and a second plurality of discs interspersed with said first set of discs with said first and second discs being enclosed within the fluid chamber;
inserting an actuator having a rotating component and a stationary component into one end of the clutch housing;
connecting the clutch housing to a differential case;
fixing the stationary component to an axle housing substantially surrounding an axle shaft;
connecting an external fluid supply to the actuator; and
using fluid from the external fluid supply to selectively transfer a locking force from the stationary component to the rotating component to selectively compress the discs together to lock the clutch housing to the axle shaft.

19. The method according to claim 18 wherein the stationary component includes a first portion substantially enclosed within the clutch housing and a leg extending transverse to the first portion and out from the clutch housing and wherein step of connecting the external fluid supply includes installing a fluid connector in the axle housing to interconnect the external fluid supply to the leg.

20. The method according to claim 19 further including the step of installing a ring in a first direction over the leg, rotating the ring approximately 90 degrees, and attaching the ring to one end of the clutch housing.

21. The method according to claim 20 further including the step of installing a first thrust bearing between the ring and the first portion of the stationary component.

22. The method according to claim 21 further including the steps of installing a piston within a piston chamber formed in the first portion of the stationary component, installing a second thrust bearing between the piston and the rotating component such that fluid from the external fluid supply selectively actuates the piston to compress the discs together via the second thrust bearing with a reaction taken by the first thrust bearing.
